(19) United States
(12) Patent Application Publication
(10) Pub. No.: US 2005/0127810 A1
(43) Pub. Date: Jun. 16, 2005

(54) Method of manufacturing electro-optical device, electro-optical device, and electronic apparatus comprising the same

(75) Inventors: Keiji Fukuhara, Eniwa-shi (JP); Minoru Moriwaki, Fuji-machi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/981,680

(22) Filed: Nov. 5, 2004

(30) Foreign Application Priority Data
Nov. 13, 2003 (JP) 2003-384066
Apr. 28, 2004 (JP) 2004-133157
Aug. 18, 2004 (JP) 2004-238055

(51) Int. Cl. H01J 29/00; B05D 5/06; B05D 5/12

(52) U.S. Cl. 313/364; 427/162; 427/58; 427/66; 313/483

(57) ABSTRACT

To provide an electro-optical device, which has a high manufacturing yield and high quality display, the electro-optical device includes above a substrate, display electrodes, at least one of wiring lines and electronic elements that drive the display electrodes, and interlayer insulating films provided below the display electrodes to electrically insulate the display electrodes and at least one of the wiring lines and electronic elements from each other. At least one of the interlayer insulating films includes a boron phosphorus silicate glass film and has its top face subjected to planarizing treatment by being put into a fluidized state.

### BACKGROUND OF THE INVENTION 1. Field of Invention

Exemplary aspects of the present invention relate to a method of manufacturing an electro-optical device, such as, for example, a liquid crystal device, the electro-optical device, and an electronic apparatus, such as, for example, a liquid crystal projector.

2. Description of Related Art

In a related art electro-optical device, display electrodes, wiring lines, such as scanning lines, data lines and the like, for driving the display electrodes, and electronic elements are laminated on each other on a substrate with interlayer insulating films therebetween. When the related art electro-optical device employs an active matrix driving method, thin film transistors (hereinafter, “TFTs”) for pixel-switching are formed on the substrate. In high temperature process type polysilicon TFTs of the pixel switching TFTs, heat treatment of 1000° C. or higher is required to form a thermally-oxidized gate insulating film. Thus, the interlayer insulating films are basically required to have heat resistance. For example, non-doped silicon oxide (such as non-doped silicate glass (NSG)) films may be used as the interlayer insulating films.

### SUMMARY OF THE INVENTION

However, when the wiring lines are formed of a material, such as aluminum (Al), that may be volatilized or deformed at a high temperature, at least an interlayer insulating film above the wring lines is required to be formed at a temperature below the heat-resistant temperature thereof. The constructional elements having such a low heat resistance generally includes wiring lines above TFTs. For example, since the melting point of Al is low, the above problem occurs in elements that contain Al from a relatively low temperature (for example, about 400° C.). Thus, as interlayer insulating films above the constructional elements having such a low heat resistance, insulating films, which can be formed even at a low temperature, such as boron phosphosilicate glass (hereinafter, “BPSG”) films, or NSG films, are used in which the NSG films are formed in a certain condition. Combinations and forming methods of the interlayer insulating films as described above are disclosed in, for example, Japanese Unexamined Patent Application Publication No. 2002-43416, Japanese Unexamined Patent Application Publication No. 2002-100621 and Japanese Unexamined Patent Application Publication No. 2002-319580.

In a related art electro-optical device like a liquid crystal device, planarizing on the surface of a TFT array substrate is actively performed to enhance display characteristics so that it is possible to reduce light leakage caused by bad liquid crystal molecular alignment, and to reduce a stripped display failure caused by a rubbing trace at the time of rubbing and a display failure caused by peeling-off of an alignment film. Techniques to reduce such display failures are disclosed in, for example, Japanese Unexamined Patent Application Publication No. 5-235040, Japanese Unexamined Patent Application Publication No. 5-249494 and Japanese Unexamined Patent Application Publication No. 7-159809.

However, on the surfaces of these interlayer insulating films, height difference occurs by the existence of wiring lines and electronic elements thereunder. Therefore, when wiring lines and the like are patterned on the interlayer insulating films, a problem occurs in that etching is not satisfactorily performed in a stepped portion, but residues are left after the etching and the manufacturing yield decreases. In recent days, since the interlayer insulating films tend to be made thin to enhance the capability of mass production or the like, the height difference on the surfaces of the films becomes larger. The above problem comes up to the surface.

Further, when there is height difference on the surface of the substrate that has been finally formed, for example, in a liquid crystal device or the like, alignment treatment on an alignment film that controls the direction in which an electro-optical material is aligned is not sufficiently performed on a stepped portion. Therefore, a problem occurs in that the deterioration of display quality, such as a partial decrease in the contrast ratio, is caused.

In a related art liquid crystal device or the like, driving by an electrical field (hereinafter, “longitudinal electrical field”) perpendicular to the surface of the substrate is generally scheduled. Therefore, when an electric field (hereinafter, “transverse electric field”) along the surface of the substrate in the vicinity of ends of pixel electrodes is generated, the display quality may deteriorate. In particular, a problem occurs too in that, if the surface of the TFT array substrate is uniformly planarized as mentioned above, a bad influence by such a transverse electric field becomes stronger all the more.

Exemplary aspects of the present invention have been made in consideration of the above and/or other problems. Exemplary aspects of the present invention provide an electro-optical device and a method of manufacturing the same, which have a high manufacturing yield and allow a high quality display, and an electronic apparatus including such an electro-optical apparatus.

In order to achieve the above, a method of manufacturing an electro-optical device of an exemplary aspect of the present invention includes, above a substrate, display electrodes, at least one of wiring lines and electronic elements that drive the display electrodes, and an interlayer insulating film provided below the display electrodes to electrically insulate the display electrodes and at least one of the wiring lines and electronic elements from each other. Specifically, the method of manufacturing an electro-optical device includes forming a boron phosphorus glass film as the interlayer insulating film on the substrate, and, subsequent to the film-forming, performing planarizing treatment on a top face of the boron phosphorus glass film by heating the boron phosphorus silicate glass film to make it fluidized.

According to the method of manufacturing an electro-optical device of an exemplary aspect of the present invention, circuits for driving display electrodes are constructed by laminating on a substrate wiring lines, such as data lines and electronic elements, such as TFTs, if necessary, while they are insulated from each other with interlayer insulating films interposed therebetween. Display electrodes are formed on the wiring lines and the electronic elements. At least one of the interlayer insulating films formed at that time is put in a fluidized state by heating immediately after it is formed as a boron phosphorus silicate glass (BPSG) film, specifically, before other treatments are performed, so that planarizing treatment is performed on the top face of the interlayer insulating film. The BPSG film has a property that is fluidized at a high temperature as in wax. On the top face of a BPSG film immediately after being formed, a height difference is caused by the existence of wiring lines and electronic elements under the film. However, when heat is applied to the BPSG film to melt it, unevenness on the top face is made uniform.

Here, the “planarizing” and “planarizing treatment” mean reducing the gradient of height difference on the top face of the interlayer insulating film and such treatment, respectively. Also, they include a case in which a step difference on the top face of the interlayer insulating film becomes gentler than that before the processing, in addition to a case in which the top face of the interlayer insulating film is made a complete flat surface. In addition, as a barometer of the planarizing, for example, the angle of inclination of the lateral face of a step in the interlayer insulating film with respect to the substrate surface may be used.

In case the top face of the interlayer insulating film is planarized in this way, when the constructional elements (wiring lines and electronic elements, or display electrodes) above the interlayer insulating film are patterned, etching residues generated in a stepped portion of the interlayer insulating film are eliminated or suppressed, so that the yield can be enhanced.

In a semiconductor substrate, a technique is known in which the surface of the substrate is planarized using such a BPSG film. However, in an electro-optical device, such as a liquid crystal device, even if BPSG is used for the interlayer insulating film, the planarizing treatment using such a technique is not performed. But chemical mechanical polishing (CMP) treatment has been adopted as the planarizing treatment. Since the CMP treatment has a possibility that internal circuits are damaged by pressure or the like that is applied to the substrate, it is performed on only an uppermost film among interlayer insulating films as bases of the display electrodes. Since the planarizing treatment according to an exemplary aspect of the present invention does not have such a possibility, the CMP treatment can be performed irrespective of a position where the interlayer insulating film is formed, so that the above-mentioned effects can be obtained.

In particular, the structure of an electro-optical device has recently been complicated for the purpose of reducing or preventing generation of a light leakage current of TFTs, and the number of layers laminated on the substrate has been increased. In such a case, in the related art, a higher layer has a larger height difference on its top face and the height difference has a great effect on pattern formation. However, according to an exemplary aspect of the present invention, planarizing treatment can be performed on respective interlayer insulating films. Accordingly, etching residues on the substrate can be reduced as a whole.

When planarizing treatment is performed on each of a plurality of laminated interlayer insulating films, a film-forming process and planarizing treatment are performed on each layer. For example, when planarizing treatment is performed on a second interlayer insulating film on which a. first interlayer insulating film has been formed, heat is also transferred to the first interlayer insulating film. However, since the shape of the first interlayer insulating film is already fixed by the planarizing treatment that was previously performed, it is extremely rare that the first interlayer insulating film is further deformed by reheating or a stress intended to be deformed is generated. Specifically, there is little possibility that a crack or the like, caused by the generation of stress in the vicinity of an interface of the first interlayer insulating film, is generated by the concerned deformation. Therefore, the interlayer insulating films according to an exemplary aspect of the present invention can be laminated without affecting the performance of an electro-optical device.

In this way, a top face of at least any one of the interlayer insulating films is planarized, so that the surface of a final substrate or a surface as a base of the display electrodes is planarized. In particular, when planarizing treatment is performed on an interlayer insulating film above the substrate, the substrate surface is effectively planarized. In this case, for example, as in a liquid crystal device in which an electro-optical material is interposed between the substrate and a counter substrate, it is possible to manufacture a liquid crystal device in which alignment treatment of an aligned film can be uniformly performed over the entire surface of the aligned film, and an aligned state of the electro-optical material is better controlled. Further, the aligned state of an electro-optical material, such as liquid crystal corresponds to the distance between substrates. Therefore, the distance between substrates is made uniform to make the aligned state of the electro-optical material uniform over the entire display surface, so that the display quality of an electro-optical device can be enhanced.

Moreover, even in case the surface of a final substrate is planarized by polishing treatment, such as CMP, when the substrate surface is made uniform in advance in this way, the polishing strength in the CMP treatment or the like can be reduced, a probability that the substrate is damaged can be reduced, and the entire surface of the substrate can be uniformly polished.

In a related art electro-optical device, a BPSG film is used as a substitute for an NSG film at the circumferences of parts (specifically, Al-containing wiring lines or the like) on a substrate that are formed by a process of a relatively low temperature. However, since a BPSG film formed in an exemplary aspect of the present invention is subjected to planarizing treatment by heating, it is used at the circumferences of parts (specifically, TFTs or the like) on a substrate that are formed by a process of a relatively high temperature.

It is noted herein that a method of forming an interlayer insulating film as the BPSG film is not particularly limited. The BPSG film is formed by, for example, a metal organic chemical vapor deposition (MOCVD) method or an atmospheric pressure CVD method. In this case, a mixed gas of each source gas, such as a TEOS (tetraethyl orthosilicate) gas, a TMOP (trimethyl oxyphosphate: PO(OCH₃)₃) gas, a TEB (triethyl borate: B(OC₂H₅)₃) gas or a TMB (trimethyl borate: B(OCH₃)₃) gas, and an oxygen (O₂) gas that contains ozone(O₃), is supplied as a reactant gas. Further, the conditions, such as the flow rate and the film formation temperature of these gases can be appropriately set.

As described above, according to the method of manufacturing an electro-optical device of an exemplary aspect of the present invention, an electro-optical device of high display quality can be manufactured at a high yield.

In one exemplary aspect of a method of manufacturing an electro-optical device of the present invention, in the first planarizing step, the boron phosphorus silicate glass film is heated at a temperature of 600° C. or higher.

The BPSG film begins to melt at a melting point according to the doped amount of boron (B) or phosphorus (P). As the temperature gets higher, the fluidity of the film increases and the planarizing on the top face proceeds. According to this aspect, the BPSG film as an interlayer insulating film is sufficiently melted by heating it at a high temperature of 600° C. or higher, so that the planarizing treatment is performed. For example, such temperature is set to a unique temperature, such as 700° C. or higher or 800° C. or higher, according to the melting point of individual BPSG films which are actually used. Specifically, the melting point and degree of melting (reflow) of a BPSG film are determined in advance through experiments, experiences, theories, or simulations, so that the flatness required according to the specification of an electro-optical device relating to an exemplary aspect of the present invention can be obtained in predetermined time. Further, the melting point and degree of melting (reflow) of the BPSG film may be individually and specifically set to a temperature that seldom causes damage to a laminated structure that has already been built below an interlayer insulating film.

In this exemplary aspect, in the first planarizing step, the boron phosphorus silicate glass film may be heated at a temperature of 900° C. or lower. If an electro-optical device is manufactured as described above, the yield can be increased. Specifically, a BPSG film that is heated at a temperature of greater than 900° C. is sufficiently melted (reflowed). However, phosphorus or boron contained in the BPSG film may be diffused in a laminated structure that has already been built below an interlayer insulating film. For example, in case phosphorus is diffused in electronic elements, such as TFTs which are formed below the BPSG film, the electrical characteristics of the TFTs deteriorates, which results in a decrease in yield of the electro-optical device concerned. Thus, the BPSG film is reflowed at 900° C. or less, so that the BPSG film can be planarized and the diffusion of phosphorus or boron contained the BPSG film can be suppressed, which makes it possible to increase the yield of an electro-optical device. Or, such temperature range may not deteriorate the performance of semiconductor elements that are built in an electro-optical device.

In this case, in the first planarizing step, the boron phosphorus silicate glass film may be heated at a temperature of 600° C. to 850° C. for a reflow time of 15 to 30 minutes. If an electro-optical device is manufactured as described above, the smoothness of a boron phosphorus silicate glass film can be enhanced while suppressing deterioration of the performance of semiconductor elements.

In the above-mentioned aspects, the method of manufacturing an electro-optical device may include forming at least parts of the wiring lines and/or electronic elements on the interlayer insulating film after planarizing treatment has been performed thereon, forming an additional interlayer insulating film on the at least parts of the wiring lines and/or electronic elements formed on the interlayer insulating film, performing a second planarizing treatment carried out at a lower temperature than that at the planarizing treatment on the formed additional interlayer insulating film, and forming the display electrodes on the additional interlayer insulating film on which the second planarizing treatment has been performed.

In this case, any other planarizing treatment, for example, CMP treatment, which is carried out at a lower temperature than that at the above planarizing treatment, is performed on another interlayer insulating film that is formed above the interlayer insulating film on which the above planarizing treatment has been performed. Therefore, for example, a low melting metal, such as aluminum that is non-resistant to heating can be used for at least parts of wiring lines and electronic elements that are formed on the interlayer insulating film. The other planarizing treatment enables the surface as a base of display electrodes to be planarized.

Moreover, the planarizing may be carried out by single wafer processing.

In this planarizing treatment, it is essential for a BPSG film to be melted to a desired extent, and the thermal management is important. Since a single wafer processing type furnace generally has a small capacity, the inside of the furnace may be maintained at constant temperature. In addition, a large-scale furnace of batch type can heat a large number of substrates at one time. However, due to temperature distribution in the furnace, the degree of planarizing may be different between substrates in the same furnace and between parts of each substrate. Further, in the planarizing treatment, the BPSG film may be melted and fluidized. It is unnecessary to heat the substrate for a long time. Therefore, when substrates are put in and out of a furnace having constant temperature in sequence, they can be efficiently processed.

In another exemplary aspect of the present invention, a groove may be formed in the substrate, and, in the planarizing step, a recessed portion of the interlayer insulating film formed corresponding to the groove may be chamfered by heating the interlayer insulating film.

According to the exemplary aspect, the smoothness of interlayer insulating films can be enhanced. In case the top face of the interlayer insulating film is planarized in this way, when the constructional elements (wiring lines and electronic elements, or display electrodes) above the interlayer insulating film are patterned, etching residues generated in a stepped portion of the interlayer insulating film are eliminated or suppressed, so that the yield can be enhanced.

In order to achieve the above, an electro-optical device of an exemplary aspect of the present invention is an electro-optical device that includes, on a substrate, display electrodes, wiring lines and/or electronic elements that drive the display electrodes, and interlayer insulating films provided below the display electrodes to electrically insulate the display electrodes and at least one of the wiring lines and electronic elements from each other. At least one of the interlayer insulating films includes a boron phosphorus silicate glass film and has its top face subjected to planarizing treatment by being put into a fluidized state.

According to the electro-optical device of an exemplary aspect of the present invention, circuits to drive display electrodes are constructed by laminating on a substrate wiring lines, such as data lines and electronic elements, such as TFTs, if necessary, while they are insulated from each other with interlayer insulating films interposed therebetween. The display electrodes are provided on the wiring lines and the electronic elements. Among them, at least one of the interlayer insulating films includes a boron phosphorus silicate glass film and has its top face subjected to planarizing treatment by being put into a fluidized state. Specifically, the BPSG film has a property that is fluidized at a relatively high temperature like wax. Height difference is caused on the top face of the BPSG film immediately after film formation by the existence of wiring lines and electronic elements below the BPSG film. However, when heat is applied to the BPSG film to fluidize it, the top face is made uniform, and unevenness by the height difference can be eliminated or reduced.

When the constructional elements (wiring lines and electronic elements, or display electrodes) formed above the interlayer insulating layer that has passed through such planarizing step are patterned, etching residues generated in a stepped portion of the interlayer insulating film are eliminated or suppressed. Therefore, the electro-optical device can be manufactured at a high yield. In particular, the structure of an electro-optical device has recently been complicated for the purpose of reducing or preventing generation of light leakage current of TFTs, and the number of layer laminated on the substrate has been increased. In such a case, in the related art, a higher layer has a larger height difference on its top face and the height difference has a great effect on pattern formation. However, according to an exemplary aspect of the present invention, planarizing treatment can be performed on respective interlayer insulating films. Accordingly, etching residues on the substrate can be reduced as a whole.

Accordingly, in the electro-optical device of an exemplary aspect of the present invention, even if the interlayer insulating films are made thin, the height difference on the top thereof is eliminated or reduced. Therefore, it is possible to manufacture the electro-optical device of high display quality at a high yield.

Further, in this exemplary aspect, the interlayer insulating film including the boron phosphorus silicate glass film may contain boron (B) in a ratio of 1 percent by weight or more and phosphorus (P) in a ratio of 7 percent by weight or less.

According to this exemplary aspect, among the interlayer insulating films, an interlayer insulating film including the BPSG film contains boron (B) of 1 percent by weight or more. Therefore, the BPSG film can be melted at a temperature suitable for implementation and can be smoothly subjected to planarizing treatment. Simultaneously, since the BPSG film contains phosphorus (P) of 7 percent by weight or less, the added phosphorus (P) is oxidized to produce phosphoric acid (P₂O₃), so as to prevent an aluminum-containing layer formed thereon from eroding. Accordingly, such an interlayer insulating film may be provided immediately below the Al-containing layer.

Further, according to this exemplary aspect, the percent by weight of phosphorus is set to 7 percent by weight or less, so that powdery spouting called water dots generated in the BPSG film after the BPSG film formation can also be reduced. The BPSG film that contains phosphorus in such a ratio becomes an interlayer insulating film that is preferable from the viewpoint of a process of mass production.

In the exemplary aspect, the interlayer insulating film may contain boron (B) in a ratio of 3 percent by weight or more and in a ratio of 5.5 percent by weight or less. The total percent by weight of boron (B) and phosphorus (P) contained in the interlayer insulating film including the boron phosphorus silicate glass film may be 10 percent by weight or less.

If the interlayer insulating film is manufactured as described above, since boron (B) is contained in a ratio of 3 percent by weight or more and 5.5 percent by weight or less, the boron phosphorus silicate glass film is properly reflowed. Moreover, since the height of a step of the boron phosphorus silicate glass film does not become excessively low, an effect of suppressing a transverse electric field caused by the step is not lowered. An alignment formed above such a step can suppress disorder of liquid crystal molecules caused by a transverse electric field, and can reduce display defects, such as decrease in contrast and generation of black domains caused by leak light. A boron phosphorus glass film that contains boron (B) in a ratio of 3 percent by weight or more and 5.5 percent by weight or less is used, so that precipitation of boron generated when the reflow is performed can be reduced and the flatness of the surface of the boron phosphorus silicate glass film hardly deteriorates. Since the boron phosphorus silicate glass film that contains boron in a ratio of 3 percent by weight or more and 5.5 percent by weight can be properly reflowed at a predetermined heating temperature to secure the surface flatness thereof, the number of wafers disposed due to precipitation of boron can be reduced and the manufacturing cost can also be reduced. The total percent by weight of boron (B) and phosphorus (P) contained in the boron phosphorus silicate glass film is set to 10 percent by weight or less, so that the deterioration of quality of the formed boron phosphorus silicate glass film can be reduced and the crack resistance of the boron phosphorus silicate glass film can be enhanced.

In still another exemplary aspect of an electro-optical device of the present invention, at least one of the wiring lines and electronic elements contains aluminum (Al), and the interlayer insulating film including the boron phosphorus silicate glass film is provided below the wiring lines and/or electronic elements that contain aluminum (Al).

According to this exemplary aspect, among the interlayer insulating films, the interlayer insulating films including the BPSG film is formed below a layer that contains Al having a low heat resistance. Generally, in order to put the BPSG film in a fluidized state, it is necessary to apply a higher temperature than the heat-resistant temperature of Al to the BPSG film. Supposing that an aluminum-containing layer is located below the BPSG film, the shape of the Al-containing layer may change by heating, which may result in deterioration of the performance of the electro-optical device and decrease of yield. Thus, when the BPSG film to be subjected to planarizing treatment is provided below the Al-containing layer, the above-mentioned problem can be avoided.

Specifically, a BPSG film in a related art electro-optical device is provided at the circumferences of Al-containing wiring lines or the like that are formed by a process of a relatively low temperature, as a substitute for an NSG film. However, since the BPSG film in this aspect is subjected to planarizing treatment, it is provided at the circumferences of parts (specifically, TFTs or the like) on a substrate that are formed by a process of a relatively high temperature.

In still another exemplary aspect of an electro-optical device of the present invention, the electro-optical device may include a counter substrate arranged to face the substrate, and an electro-optical material interposed between the substrate and the counter substrate.

According to this exemplary aspect, an electro-optical material is interposed between the substrate having display electrodes provided thereon and the counter electrode, for example, as in a liquid crystal device. The outermost surface of each substrate is provided with, for example, an alignment film that controls an aligned state of the electro-optical material. Here, at least one of the interlayer insulating films is a BPSG film on which planarizing treatment has been performed. As a result, the surface of a final substrate is planarized. Therefore, the alignment treatment of the alignment film can be uniformly performed over the entire surface thereof, and the alignment state of the electro-optical material can be better controlled. In particular, the alignment film formed on the display electrodes can also be subjected to rubbing treatment while reducing spots. Accordingly, display spots or stain can be reduced or prevented from being generated due to a partial decrease in contrast ratio.

Further, the aligned state of an electro-optical material, such as liquid crystal corresponds to the distance between substrates. Therefore, when the distance between the substrates is made uniform by planarizing of the substrate surfaces, the aligned state of the electro-optical material is made uniform over the entire display surface. Accordingly, display spots or stain can be reduced or prevented from being generated.

Even in case the surface of a final substrate is planarized by polishing treatment, such as CMP, when the substrate surface is made uniform in advance in this way, the polishing strength in the CMP treatment or the like can be reduced, a probability that the substrate is damaged can be reduced, and the entire surface of the substrate can be uniformly polished, which are preferable.

In order to achieve the above, an electronic apparatus of an exemplary aspect of the present invention includes the above-mentioned electro-optical device (including various aspects thereof) of an exemplary aspect of the present invention.

According to the electronic apparatus of an exemplary aspect of the present invention, since the electronic apparatus includes the above-mentioned electro-optical device of an exemplary aspect of the present invention, various electronic apparatus can be realized, such as a projection display device, a liquid crystal television, a mobile telephone, an electronic organizer, a word processor, a view finder type or a monitor direct view video tape recorder, a workstation, a television telephone, a POS terminal, a touch panel, which make it possible to perform high-quality display. Further, as electro-optical devices of exemplary aspects of the present invention, a display device (Field Emission Display and Surface-Conduction Electron-Emitter Display) using an electron emission element can be realized other than an electrophoresis device such as, for example, an electronic paper.

In order to achieve the above, a method of manufacturing an electro-optical device of an exemplary aspect of the present invention is a method of manufacturing an electro-optical device in which an electro-optical material is interposed between a pair of substrates, display electrodes, at least one of wiring lines and electronic elements that drive the display electrodes, and an interlayer insulating film provided below the display electrodes to electrically insulate the display electrodes and at least one of the wiring lines and electronic elements from each other, are provided on one of the pair of substrates. A counter electrode is provided on the other of the pair of substrates to face the display electrodes. The method of manufacturing an electro-optical device includes forming on the one substrate a boron phosphorus silicate glass film as the interlayer insulating film, and, subsequent to the film-forming, performing a first planarizing treatment on a top face of the boron phosphorus silicate glass film while the height of a convex portion formed on the top face of the boron phosphorus silicate film is kept constant.

According to a method of manufacturing an electro-optical device of an exemplary aspect of the present invention, the height of the convex portion before and after the planarizing treatment is kept constant. Here, the expression “the height of the convex portion is kept constant” means that the height from a region of the top face of the boron phosphorus silicate glass film parallel to the substrate to an apex of the convex portion is maintained. Accordingly, the planarizing treatment decreases the angle of inclination at which the lateral face of the convex portion is formed with respect to the substrate, so that the lateral face of the convex portion can be made gentle. As a result, for example, a transverse electric field that is one of causes by which the alignment of liquid crystal molecules is disordered, can be reduced or prevented at the convex portion. Further, since the lateral face of the convex portion is made gentle by the planarizing treatment, it is possible to reduce the peeling-off of an alignment film formed above the convex portion thereof, which may occur when the alignment film is rubbed. Accordingly, the yield of electro-optical devices can be enhanced, and a decrease in contrast caused by disorder of the alignment of liquid crystal molecules can be suppressed.

The operations and other advantages of the present invention will be apparent from the exemplary embodiments described below.

### BRIEF DESCRIPTION OF THE DRAWINGS

FIG. 1 is a circuit schematic illustrating an electro-optical device according to one embodiment of the present invention;

FIG. 2 is a schematic illustrating the specific construction of the electro-optical device illustrated in FIG. 1;

FIG. 3 is a schematic taken along the plane A-A′ in FIG. 2;

FIGS. 4A-4C illustrate processes for explaining a method of manufacturing the electro-optical device in the exemplary embodiment;

FIGS. 5A-5C illustrate processes subsequent to the processes in FIG. 4;

FIGS. 6A and 6B illustrate processes subsequent to the processes in FIG. 5;

FIG. 7 is a schematic illustrating the general construction of a liquid crystal device in the exemplary embodiment;

FIG. 8 is a schematic taken along the plane H-H′ in FIG. 7;

FIG. 9 is a schematic illustrating the construction of a liquid crystal projector according to one exemplary embodiment of an electronic apparatus of the present invention;

FIG. 10 is a schematic according to the exemplary embodiment of the present invention;

FIG. 11 is a graph representing measurement results according to the exemplary embodiment of the present invention; and

FIG. 12 is a graph representing measurement results according to the exemplary embodiment of the present invention.

### DETAILED DESCRIPTION OF EXEMPLARY EMBODIMENTS

Hereinafter, exemplary embodiments of the present invention will be described with reference to the accompanying drawings. In the following exemplary embodiments, an electro-optical device of an exemplary aspect of the present invention is applied to a liquid crystal device.

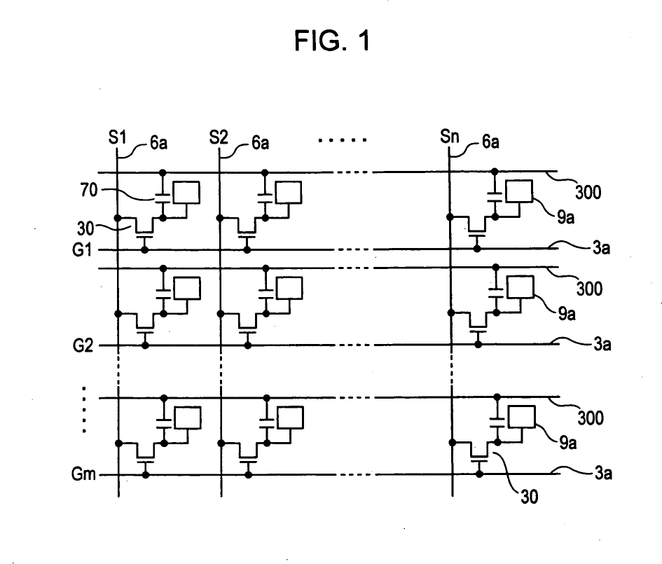

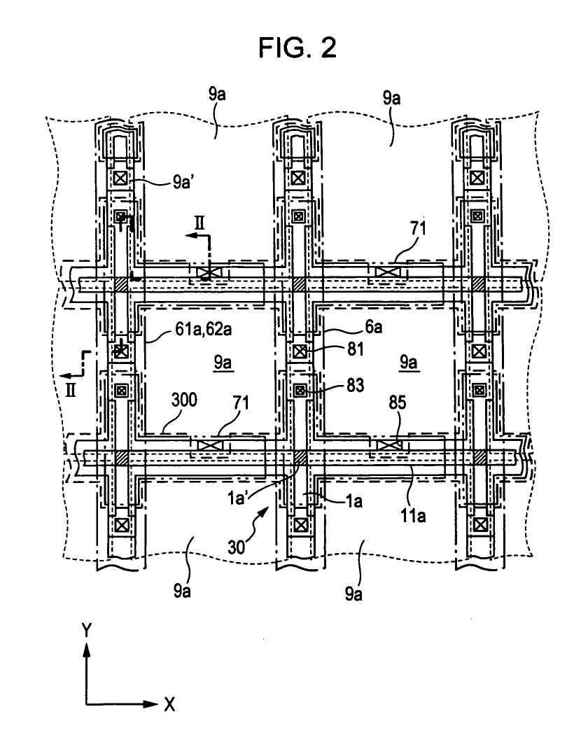

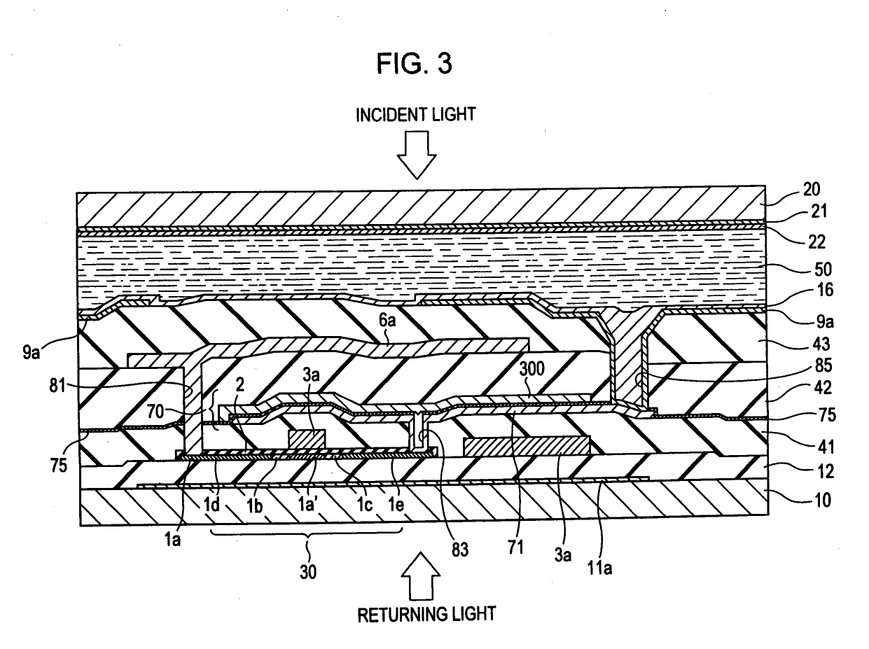

First, an electro-optical device of one exemplary embodiment of the present invention will be described with reference to FIGS. 1 to 3. FIG. 1 is a circuit schematic of various elements, wiring lines and the like in a plurality of pixels that are formed in a matrix and that constitute an image display region of the electro-optical device. FIG. 2 is a schematic of a group of adjacent plural pixels of a TFT array substrate on which data lines, scanning lines, pixel electrodes and the like are formed. FIG. 3 is a schematic taken along the plane A-A′ in FIG. 2. In addition, scales of respective layers and members in FIG. 3 are made different from each other so that the respective layers and members have sizes capable of being recognized in the drawings.

In FIG. 1, pixel electrodes 9a and TFTs 30 to control switching of the pixel electrodes 9a are respectively formed in the plurality of pixels that are formed in a matrix and that constitute the image display region of the electro-optical device in the present exemplary embodiment. Also, data lines 6a to which image signals are supplied are electrically connected to the sources of the TFTs 30. Image signals S1, S2, . . . , and Sn to be written may be line-sequentially supplied in this order to the data lines 6a, or may be supplied to every group including a plurality of adjacent data lines 6a. The scanning lines 3a are electrically connected to gate electrodes of the TFTs 30. Also, scanning signals G1, G2, . . . , and Gm are line-sequentially applied in this order to the scanning lines 3a in pulses at a predetermined timing. The pixel electrodes 9a are electrically connected to the drains of the TFTs 30. Also, switches of the TFTs 30 that are switching elements are closed only for a fixed period, so that the image signals S1, S2, . . . , and Sn supplied from the data lines 6a are written at predetermined timing. Also, a predetermined level of image signals S1, S2, . . . , and Sn written in liquid crystal as an example of an electro-optical material via the pixel electrodes 9a are stored for a fixed period between the pixel electrodes 9a and a counter electrode formed in a counter substrate, which will be described below. The alignment and order of liquid crystal molecules change by the level of an applied voltage, so that liquid crystal allows light to be modulated and allows grayscale display to be performed. In a normally white mode, the transmittance of incident light decreases corresponding to a voltage applied to each pixel. In a normally black mode, the transmittance of incident light increases corresponding to a voltage applied to each pixel. Thus, light that has contrast corresponding to an image signal emits from an electro-optical device as a whole. Here, storage capacitors 70 are added in parallel to liquid crystal capacitors formed between the pixel electrodes 9a and the counter electrode, thereby reducing or preventing stored image signals from leaking.

### Construction of Electro-optical Device

In FIG. 2 and FIG. 3, a plurality of transparent pixel electrodes 9a (whose outlines are denoted by dotted lines 9a′) are provided in a matrix on a TFT array substrate of an electro-optical device. Also, a data line 6a and a scanning line 3a are respectively provided along vertical and horizontal boundaries of each of the pixel electrodes 9a.

Further, the scanning line 3a is arranged to face a channel region 1a′ of a semiconductor layer 1a that is denoted in FIG. 2, by right upward slanted lines. The scanning line 3a includes a gate electrode. As described above, a pixel switching TFT 30 is provided at each intersection of the scanning line 3a and the data lines 6a, and a part of the scanning line 3a as a gate electrode is arranged to face the channel region 1a′ of the TFT 30.

The data line 6a has a second interlayer insulating film 42 whose top face are planarized formed as its base, and is connected to a highly doped source region 1d of the TFT 30 via a contact hole 81. The data line 6a and the inside of the contact hole 81 includes, for example, a layer that contains Al (aluminum), such as Al—Si—Cu and Al—Cu, or a layer of Al element; or a multilayer film including the Al-containing layer or Al element layer, a TiN layer, and the like. Further, the data line 6a is formed to cover a region in which the TFT 30 is formed to function as a light-shielding film for the TFT 30.

The storage capacitor 70 is constructed such that a lower capacitor electrode 71 as a pixel-potential-side capacitor electrode, which is electrically connected to a highly doped drain region 1e of the TFT 30 and the pixel electrode 9a, and a part of the upper capacitor electrode 300 as a fixed-potential-side capacitor electrode are arranged to face each other with a dielectric film 75 therebetween. The lower capacitor electrode 71 and the pixel electrode 9a may be connected to each other via a relay film.

The upper capacitor electrode 300 is formed of a conductive light-shielding film including, for example, metal or alloy, and is provided above the TFT 30 to cover the TFT 30 as an upper light-shielding film (a built-in light shielding film). Further, the upper capacitor electrode 300 also functions as a fixed-potential-side capacitor electrode. The upper capacitor electrode 300 includes, for example, a layer made of a metallic element containing any one of refractory metals, such as Ti (titanium), Cr (chrome), W (tungsten), Ta (tantalum), Mo (molybdenum), and Pd (palladium), or a layer made of an alloy containing two or more thereof; or a layer made of metal silicide, a layer made of polysilicide, or a laminate of these layers. Alternatively, the upper capacitor electrode 300 may contain metal other than Al (aluminum), Ag (silver), or the like, which has a low resistance. However, the upper capacitor electrode 300 may have, for example, a multilayer structure in which a first film including a conductive polysilicon film or the like, and a second film including a metal silicide film or the like containing refractory metals are laminated.

The lower capacitor electrode 71 includes, for example, a conductive polysilicon film, and functions as a pixel-potential-side capacitor electrode. The lower capacitor electrode 71 is arranged between the upper capacitor electrode 300 as an upper light-shielding film, and the TFT 30, to function as a light absorptive layer other than to function as a pixel-potential-side capacitor electrode. Moreover, the lower capacitor electrode 71 has a function to relay-connect the pixel electrode 9a and the highly doped drain region 1e of the TFT 30. However, the lower capacitor electrode 71 may include a single-layered film or a multi-layered film that contains metal or alloy, similar to the upper capacitor electrode 300 instead of the aforementioned function.

The dielectric film 75 arranged between the lower and upper capacitor electrode 71 and 300 as capacitor electrodes includes, for example, a silicon oxide film, such as a high temperature oxide (HTO) film and a low temperature oxide (LTO) film, or a silicon nitride film, which has a comparatively small film thickness of 5 to 200 nm (nanometers). From the viewpoint of increasing the capacity of the storage capacitor 70, a thinner dielectric film 75 is better as long as the reliability of the film can be sufficiently obtained.

Further, the upper capacitor electrode 300 extends from the image display region in which the pixel electrode 9a is arranged to the periphery thereof, and is electrically connected to a potentiostatic source to have a fixed potential. The concerned potentiostatic source may include a potentiostatic source of positive power or negative power that is supplied to a later-described scanning line driving circuit to supply scanning signals to drive the TFT 30 to the scanning line 3a, and a later-described data line driving circuit to control a sampling circuit that supplies image signals to the data line 6a. Alternatively, a controlled potential may be supplied to a counter electrode 21 of the counter substrate 20.

A lower light-shielding film 11a is provided below the TFT 30 in a lattice to extend along the scanning line 3a and the data line 6a with a base insulating film 12 therebetween and to overlap them.

The lower light-shielding film 11a is provided to shield the channel region 1a′ of the TFT 30 and its peripheral region from returning light that enters the electro-optical device from the TFT array substrate 10 side. Similar to the upper capacitor electrode 300 that constitutes an example of the upper light-shielding film, the lower capacitor electrode film 11a includes, for example, a layer made of a metallic element containing any one of refractory metals, such as Ti, Cr, W, Ta, Mo, and Pd, or a layer made of an alloy containing two or more thereof; or a layer made of metal silicide, a layer made of polysilicide, or a laminate of these layers. Moreover, in order to reduce or prevent potential fluctuation from affecting the TFT 30, similar to the upper capacitor electrode 300, the lower light-shielding film 11a may also extend from the image display region to the periphery thereof so as to be connected to a potentiostatic source.

The base insulating film 12 has a function to interlayer-insulate the lower light-shielding film 11a and the TFT 30 from each other. Moreover, since the base insulating film 12 is formed on the entire surface of the TFT array substrate 10, it has a function to reduce or prevent characteristics of the pixel-switching TFT 30 from deteriorating due to the roughness of the surface of the TFT array substrate 10 at the time of polishing thereof or dirt left after cleaning the surface.

The pixel electrode 9a is electrically connected to the highly doped drain region 1e of the semiconductor layer 1a via the contact holes 83 and 85 by relaying the lower capacitor electrode 71. That is, in the present exemplary embodiment, the lower capacitor electrode 71 has a function to relay-connect the pixel electrode 9a to the TFT 30, in addition to the function as a pixel-potential-side capacitor electrode of the storage capacitor 70 and the function as a light absorptive layer. If the lower capacitor electrode 71 is used as described above, it is possible to decrease the depth of contact holes, even if the interlayer distance between the pixel electrode 9a and the highly doped drain region 1e is long to the extent of, for example, about 2000 nm. It is possible to avoid technical difficulties in connecting the pixel electrode 9a and the highly doped drain region 1e to each other with one contact hole. Further, it is possible to connect the pixel electrode 9a and the highly doped drain region 1e to each other with a contact hole or a groove. As a result, the pixel aperture ratio can be raised, so that it is also helpful to reduce the likelihood or prevent the highly doped drain region 1e from being pierced by etching in forming a contact hole.

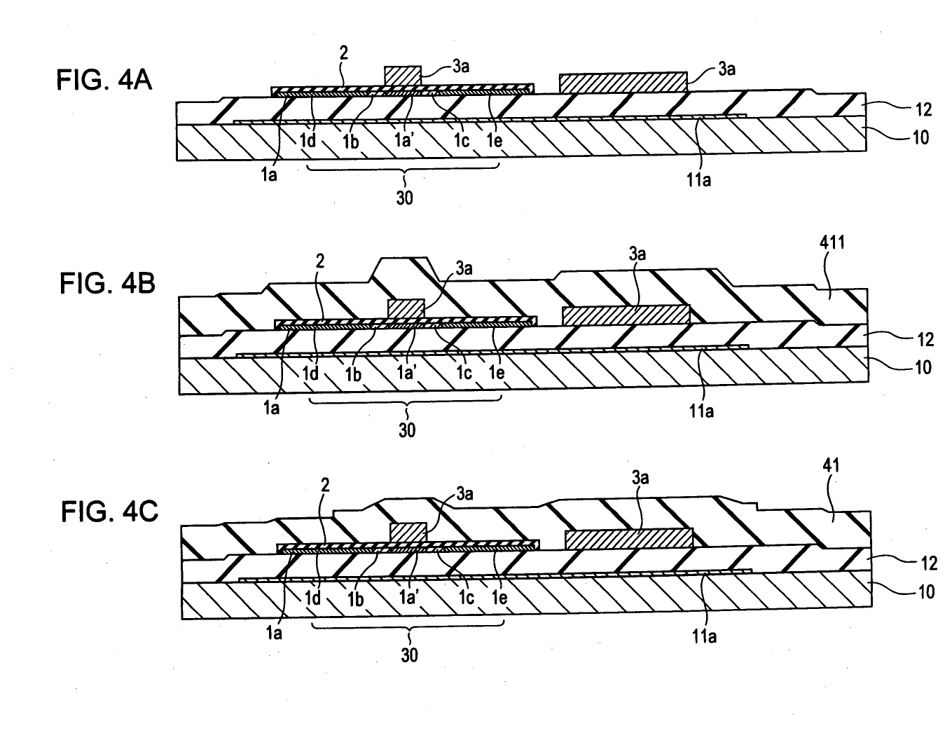

As shown in FIG. 3 and FIGS. 4A-4C, the electro-optical device includes the transparent TFT array substrate 10, and the transparent counter substrate 20 to face it. The TFT array substrate 10 includes, for example, a quartz substrate, a glass substrate, or a silicon substrate, and the counter substrate 20 includes, for example, a glass substrate or a quartz substrate.

The TFT array substrate 10 is provided with the pixel electrode 9a on which (on the electro-optical material side) an alignment film 16 subjected to a predetermined alignment treatment, such as a rubbing treatment is provided. The pixel electrode 9a includes, for example, a transparent conductive film, such as an ITO (Indium Tin Oxide) film. Further, the alignment film 16 includes, for example, an organic film, such as a polyimide film.

The counter substrate 20 is provided with the counter electrode 21 over the entire surface thereof. An alignment film 22 subjected to a predetermined alignment treatment, such as a rubbing treatment is provided under the counter electrode (on the counter substrate 20 side or the light-incident side) in FIG. 3. The counter electrode 21 includes, for example, a transparent conductive film, such as an ITO film. Further, the alignment film 22 includes an organic film, such as a polyimide film. Latticed or striped light-shielding films may be provided in the counter substrate 20. This construction is employed together with the data line 6a and the upper light-shielding film provided as the upper capacitor electrode 300, so that the incident light from the TFT array substrate 10 side can be prevented from invading the channel region 1a′ and its peripheral region. In addition, the light-shielding film on the counter substrate 20 is formed to have a higher reflectance on at least the surface thereof that is irradiated with external light. As a result, temperature rise of the electro-optical device can be reduced or prevented.

According to the above construction, the liquid crystal that is an example of the electro-optical material is sealed in a space surrounded by a later-described sealing material between the TFT array substrate 10 and the counter substrate 20 in which the pixel electrode 9a and the counter electrode 21 are respectively arranged to face each other, with the result that a liquid crystal layer 50 is formed. The liquid crystal layer 50 takes a predetermined alignment state by the alignment films 16 and 22 in a state that an electric field from the pixel electrode 9a is not applied thereto. The liquid crystal layer 50 includes, for example, one kind of liquid crystal, or liquid crystal in which various kinds of nematic liquid crystal are mixed with each other. Otherwise, the liquid crystal layer 50 may include liquid crystal having a negative dielectric anisotropy, which can be vertically aligned. The sealing material mainly includes an adhesive made of, for example, a photo-curable resin or a thermosetting resin so as to adhere the TFT array substrate 10 and the counter substrate 20 to each other at the peripheries of both the substrates. A gap material, such as glass fiber or glass beads is mixed in the adhesive so that the distance between both the substrates is a predetermined value.

In FIG. 3, the pixel-switching TFT 30 includes the semiconductor layer 1a, a gate electrode, and a gate insulating film 2 that insulates the gate electrode and the semiconductor layer 1a. Also, the semiconductor layer 1a has a lightly doped drain (LDD) structure. The LDD structure includes a channel region 1a′ of the semiconductor layer 1a in which a channel is formed by an electric field from the gate electrode, a lightly doped source region 1b and a lightly doped drain region 1c of the semiconductor layer 1a, and a highly doped source region 1d and a highly doped drain region 1e of the of the semiconductor layer 1a.

In the present exemplary embodiment, a first interlayer insulating film 41 is formed to cover the entire surface of the base insulating film 12 from the top of the gate electrode and the scanning line 3a. The first interlayer insulating film 41 includes a BPSG film that contains boron (B) in a ratio of 1 percent by weight or more and phosphorus (P) of 7 percent by weight or less. The top face of the first interlayer insulating film is planarized by passing through a fluidization state by heating. Specifically, at the time of formation of a BPSG film, height difference is caused on the top face of the BPSG film by the existence of the TFT 30, the scanning line 3a, and the base light-shielding film 11a. However, once the BPSG film is fluidized, the unevenness caused by the height difference is leveled. The top face of the first interlayer insulating film is planarized. The planarizing treatment will be described below. Here, in order to fluidize the BPSG film once, the first interlayer insulating film 41 contains boron (B) of 1 percent by weight or more, for example, 2 percent by weight.

Further, a storage capacitor 70 is formed on the first interlayer insulating film 41. Since the first interlayer insulating film 41 to be a base is planarized, at the time of formation of the storage capacitor 70, etching residues in a step on the base is hardly generated, so that the storage capacitor is patterned in a good state.

The first interlayer insulating film 41 is respectively formed with the contact hole 81 that leads to the highly doped source region 1d and the contact hole 83 that leads to the highly doped drain region 1e.

Further, in the present exemplary embodiment, a second interlayer insulating film 42 is formed to cover the entire surface of the first interlayer insulating film 41 from the top of the storage capacitor 70. The second interlayer insulating film 42 also includes a BPSG film that contains boron (B) in a ratio of 1 percent by weight or more and phosphorus (P) of 7 percent by weight or less. The top face of the second interlayer insulating film is subjected to planarizing treatment by passing through a fluidization state by heating. Here, in order to fluidize the BPSG film once, the second interlayer insulating film 42 contains boron (B) of 1 percent by weight or more, for example, 2 percent by weight. Also, since the data line 6a formed on the second interlayer insulating film 42 contains aluminum (Al), the concentration of phosphorus (P) is set to 7 percent by weight or less, for example, 6 percent by weight. The reason is because, if the data line 6a contains phosphorus (P) of 7 percent by weight or more, phosphorus oxides that corrode Al may be generated.

The planarizing treatment increases the flatness of the top face of the second interlayer insulating film 42. As a result, in the data line 6a provided on the top face, etching residues are hardly generated at the time of formation thereof, so that the data line is patterned in a good state. In addition, the contact holes 81 and 85 are respectively formed in the second interlayer insulating film 42. Moreover, a third interlayer insulating film 43, formed with the contact hole 85, is formed to cover the entire surface of the second interlayer insulating film 42 from the top of the data line 6a. The third interlayer insulating film 43 is not subjected to planarizing treatment by heating because the data line 6a containing Al exists under the third interlayer insulating film. The pixel electrode 9a and the alignment film 16 are provided on the top face of the third interlayer insulating film 43.

### Manufacturing Process

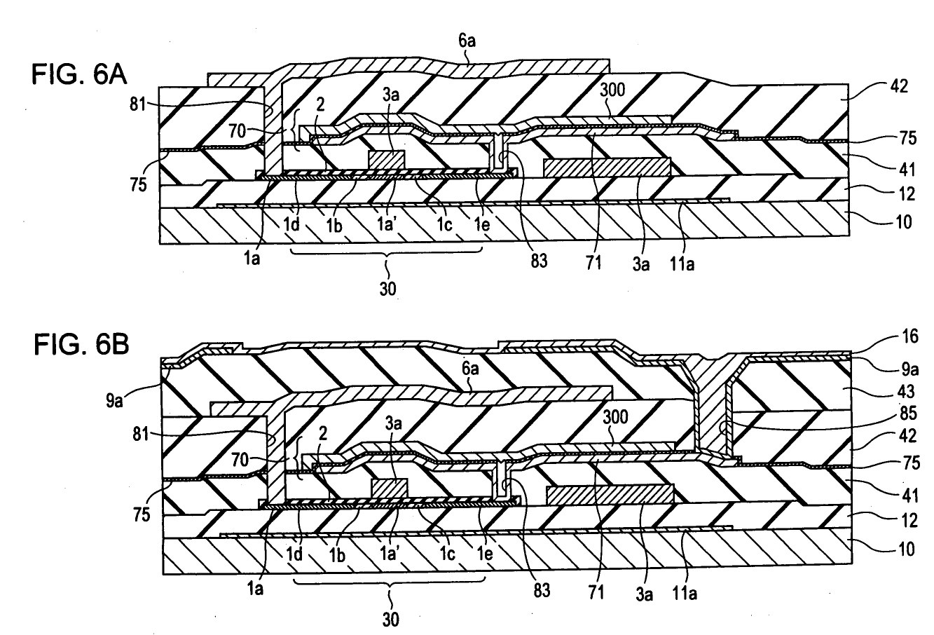

Next, processes of manufacturing the above-described electro-optical device will be described with reference to FIG. 6 from FIGS. 4A-4C. Here, FIGS. 4A-4C to 6 are process charts illustrating the sectional structure in a point corresponding to the plane A-A′ illustrated in FIG. 3 process by process.

First, in a process of FIG. 4A, the substrate 10, such as a silicon substrate, a quartz substrate, or a glass substrate, is prepared. Here, the substrate 10 is annealed and preprocessed in an atmosphere of, preferably, inert gas, such as nitrogen (N₂), at about 850 to 1300° C., preferably, at a high temperature of 1000° C., so as to decrease distortion which may be caused in the substrate 10 in a high temperature process, which is carried out later.

Subsequently, a light-shielding layer is formed on the entire surface of the substrate 10 as thus preprocessed, to have a film thickness of about 100 to 500 nm, preferably, about 200 nm, using a film made of metal, such as Ti, Cr, W, Ta, Mo or Pd, or a film made of alloy, such as metal silicide by a sputtering method. Thereafter, a lower light-shielding film 11a is formed to have the pattern as shown in FIG. 2 by photolithography and etching.

Subsequently, on the lower light-shielding film 11a, the base insulating film 12 that includes a silicate glass film, a silicon nitride film, or a silicon oxide film made of NSG, PSG, BSG, or BPSG is formed using a tetraethyl orthosilicate (TEOS) gas, a triethyl borate (TEB) gas, a trimethyl oxyphosphate (TMOP) gas by an atmospheric pressure or reduced-pressure CVD method or the like.

Subsequently, an amorphous silicon film is formed and annealed on the base insulating film 12 by a reduced-pressure CVD method or the like. As a result, a polysilicon film grows from solid phase. Otherwise, a polysilicon film is directly formed without an amorphous silicon film by a reduced-pressure CVD method or the like. Next, the polysilicon film passes through a photolithography process, an etching process or the like, so that a semiconductor layer 1a is formed to have a predetermined pattern as shown in FIG. 2. Further, the polysilicon film is thermally oxidized to form an insulating film 2 to be a gate insulating film. As a result, the semiconductor layer 1a has a thickness of about 30 to 150 nm, preferably, a thickness of about 35 to 50 nm, and the insulating films 2 has about a thickness of about 20 to 150 nm, preferably, a thickness of about 30 to 100 nm.

Subsequently, a polysilicon film is deposited to have a thickness of about 100 to 500 nm by a reduced-pressure CVD method or the like, and phosphorus (P) is thermally diffused thereon to make the polysilicon film electrically conductive. Thereafter, a scanning line 3a is formed to have a predetermined pattern illustrated in FIG. 2 by a photolithography process, an etching process or the like. Next, impurity ions are doped by two steps of low concentration and high concentration, so that a semiconductor layer 1a of a pixel-switching TFT 30 is formed that has an LDD structure including a lightly doped source region 1b, a lightly doped drain region 1c, a highly doped source region 1d and a highly doped drain region 1e.

Next, in a process of FIG. 4B, a BPSG film 411 is formed using, for example, an atmospheric pressure CVD method. At this time, the BPSG film 411 is formed by adjusting the amount of impurities to be added so as to contain boron (B) in a ratio of 1 percent by weight or more and phosphorus (P) of 7 percent by weight or less, specifically, boron (B) of 2 percent by weight or more and phosphorus (P) of 6 percent by weight or less.

At that time, as a film formation gas, a nitrogen (N₂) gas, an O₃ gas, a TEOS gas, a TMOP (trimethyl oxyphosphate: PO(OCH₃)₃) gas or a TEB (triethyl borate: B(OC₂H₅)₃) gas are supplied onto the substrate. Any gas of those gases is supplied at the beginning so that the amount thereof increases gradually. At the point of time five seconds have elapsed, the amount of the gas to be supplied is kept constant. At the point of time when the amount supplied is kept constant, the flow rate of the respective gases, for example, the N₂ gas and O₃ gas is respectively 18 l/min and 7.5 l/min. For example, the flow rate of the TEOS gas is 2.5 l/min, the flow rate of the TMOP gas is 1.2 l/min, and the flow rate of the TEB gas is 0.55 l/min.

On the top face of the BPSG film 411 as thus obtained, as illustrated in the. drawing, unevenness corresponding to shapes of the TFT 30 and the scanning line 3a below the BPSG film is caused.

The ratios of boron and phosphorus contained in the BPSG film 411 are not limited to those as described above. For example, as in the BPSG film 411, it is preferable that the interlayer insulating film contains boron (B) in a ratio of 3 percent by weight or more and 5.5 percent by weight or less, and the total percent by weight of boron (B) and phosphorus (P) contained in the BPSG film 411 is 10 percent by weight or less. This is because that, if the total percent by weight of boron (B) and phosphorus (P) contained in the BPSG film 411 exceeds 10 percent by weight, the quality of the BPSG film 411 to be formed deteriorates, and resistance to cracking deteriorates. Moreover, it is preferable that the percent by weight of phosphorus (P) is 7 percent by weight or less. The reason is because, in a case that the percent by weight of phosphorus contained in the BPSG film 411 to be formed exceeds 7 percent by weight, if the BPSG film 411 is left in the atmosphere, powdery spouting, referred to as water dots, is generated in a short time. It is not preferable in a process of mass production that water dots are generated in a short time after film formation. In addition, the inventors of this application have investigated the situations that water dots are generated. The results of the investigation will be described in the following exemplary embodiments.

Further, the percent by weight of boron (B) in the BPSG film 411 is 3 percent by weight or more and 5.5 percent by weight or less. The reason why this situation is preferable is based on the followings. If the percent by weight of boron (B) is less than 3 percent by weight, the reflow property of the BPSG film 411 cannot be sufficiently obtained, and it becomes difficult for the inclination of the lateral face of a step provided on the surface of the substrate to be made gentle. As a result, display defects due to rubbing are generated. If the percent by weight of boron (B) exceeds 5.5 percent by weight, the BPSG film 411 is excessively reflowed so that the height of the convex portion like a step formed on the surface of the BPSG film 411 decreases as compared to that before the reflow. In many cases, the step whose height becomes smaller than that before the reflow is not maintained at an enough height to prevent a transverse electric field. Accordingly, it becomes difficult to control the alignment of liquid crystal molecules in the entire display surface, so that contrast degradation caused by light leakage, and display failure, such as, for example, generation of a black domain, are generated. Further, if the percent by weight of boron (B) exceeds 5.5 percent by weight, since boron precipitates on the surface by reflow processing and the smoothness of the surface of the BPSG film 411 deteriorates, a wafer into which a laminated structure is made should be disposed. Such disposal of a wafer causes a problem in terms of effective use of resources and cost.

Accordingly, the percent by weight of boron (B) of the BPSG film 411 is set to 3 percent by weight or more and 5.5 percent by weight or less, so that the aforementioned various display defects are reduced to increase the contrast ratio, which leads to the effective use of resources.

Next, in a process of FIG. 4C, the BPSG film 411 is fluidized by heating, and subjected to planarizing treatment. Specifically, the substrate is heated to about 600° C. or more, for example, about 800° C. to 1000° C. to melt the BPSG film 411. In the present exemplary embodiment, this process is performed by heat treatment in a furnace of 1000° C. and an N₂ atmosphere for 20 minutes. Since the BPSG film 411 contains boron (B) of 1 percent by weight, it is melted, specifically, reflowed below the above temperature. As a result, the first interlayer insulating film 41 reduced in height difference in the top face is formed.

Single wafer processing may be used in the heat treatment process because it is accompanied with reflow. In the related art, batching processing by a vertical diffusion furnace is adopted for heat treatment of an interlayer insulating film. In that case, the duration is, for example, about 8 to 9 hours. In the single wafer processing, since the duration per one wafer can be shortened to about 5 minutes, and the processing speed also increases as a whole, it is extremely advantageous in terms of manufacturing efficiency.

Further, the temperature at which the BPSG film 411 may be heated is 600° C. or more and 900° C. or less. This is because the BPSG film 411 is reflowed in such a range of temperature, so that boron and phosphorus of the BPSG film 411 is thermally diffused into an electronic element like the TFT 30. When the BPSG film 411 is reflowed at a temperature of 900° C. or less, a decrease in the withstand voltage between the source and gate (S/D) of the TFT 30, and an increase in off-state current (Ioff) can be suppressed, which make it possible to decrease point defect system failures. Preferably, the reflow temperature of the BPSG film 411 may be set to 600° C. or more and 850° C. or less, and the reflow time thereof may be set to 15 minutes to 30 minutes. According to such reflow conditions, boron and phosphorus of the BPSG film 411 can be inhibited from being thermally diffused in an electronic element like the TFT 30, and the surface of the BPSG film 411 can be planarized. while the height difference of the BPSG film 411, i.e., the height of the convex portion is kept constant.

Here, the expression “the surface of the BPSG film 411 is planarized while the height of the step, i.e., the convex portion of the BPSG film 411 is kept constant” means that the BPSG film 411 is fluidized so that the inclination of the lateral of the step is made gentle, and the height of the step is kept constant before and after the surface is planarized. In addition, in order to reflow the BPSG film 411 while inhibiting the thermal diffusion of phosphorus and boron, it is preferable that the BPSG film is reflowed at 850° C. Further, the step formed in the substrate is not limited to the convex portion, and the step may include an uneven portion formed on the surface of the BPSG film 411 corresponding to a trench formed in the substrate. The BPSG film formed to cover such a trench is heated so that the BPSG film that covers the trench can be chamfered. Specifically, a depression of the BPSG film that covers the trench is chamfered so that the BPSG film can be planarized.

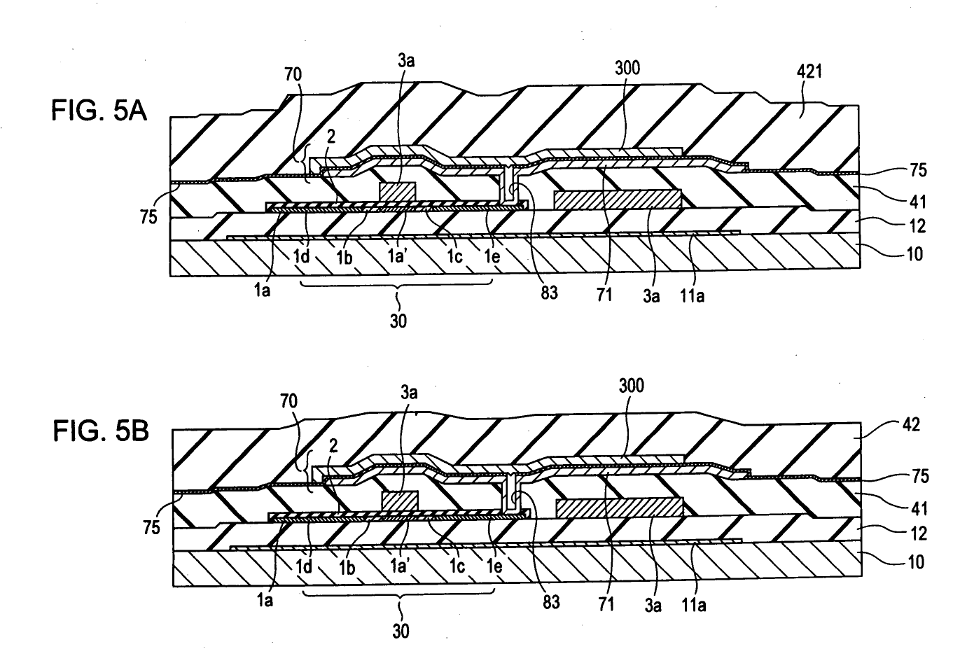

Next, in a process of FIG. 5A, a storage capacitor 70 and an insulating film 421 are formed. First, contact holes 81 and 83 are formed in the first interlayer insulating film 41 by dry etching, wet etching, or a combination thereof. Next, a polysilicon film is deposited by a reduced-pressure CVD method or the like, phosphorus (P) is further diffused to make the polysilicon film electrically conductive. As a result, a lower capacitor electrode 71 is formed. Moreover, after a dielectric film 75 including a high temperature oxidation silicon film (an HTO film) or a silicon nitride film is deposited to have a relatively small film thickness of about 50 nm by a reduced-pressure CVD method, a plasma CVD method or the like, a film made of metal, such as Ti, Cr, W, Ta, Mo or Pd, or alloy metal, such as metal silicide is sputtered to form an upper capacitor electrode 300. As a result, a storage capacitor 70 is formed.

Here, dry etching allows the lower capacitor electrode 71 and the upper capacitor electrode 300 to be patterned. In this case, since the step of the first interlayer insulating film 41 that is a base of the lower and upper capacitor electrodes is considerably planarized, etching residues are hardly generated and a surface state after patterning is enhanced.

Subsequently, a BPSG film 421 is formed using, for example, an atmospheric pressure CVD method. The BPSG film 421 is formed similar to, for example, the BPSG film 411. A step having a shape corresponding to, mainly, that of the storage capacitor 70 is formed on the top face of the obtained BPSG film 421.

Next, in a process of FIG. 5B, the BPSG film 421 is fluidize by heating, and subjected to planarizing treatment. In the present exemplary embodiment, this processing is performed by, for example, heat treatment in a furnace of 890° C. and an N₂ atmosphere for 20 minutes. Since the BPSG film 421 contains boron (B) of 1 percent by weight or more, it is reflowed below the above temperature. As a result, the second interlayer insulating film 42 reduced in height difference in the top face is formed. In this case, from the viewpoint of manufacturing efficiency, single wafer processing may be used in the heat treatment process.

In this process, heat is transferred to the first interlayer insulating film 41 to melt it as well as the second interlayer insulating film 42. However, since the shape of the first interlayer insulating film 41 is already fixed by the planarizing treatment that was previously performed, it is extremely rare that the first interlayer insulating film is further deformed by reheating. Therefore, in the present exemplary embodiment, the first interlayer insulating film 41 and second interlayer insulating film 42 respectively on which the planarizing treatment has been performed can be laminated without bringing about harmful effect on the performance of the electro-optical device.

Next, in a process of FIG. 6A, a data line 6a is formed on the second interlayer insulating film 42. First, dry etching, such as reactive ion etching and reactive ion beam etching is performed on the second interlayer insulating film 42 so that a contact hole 81 is formed. Thereafter, a wiring material that contains Al, such as Al and Al alloy, is deposited on the entire surface of the second interlayer insulating film 42 by sputtering and the like. Then, photolithography and etching are performed on the deposited film so that a data line 6a is formed to have a predetermined pattern.

Here, dry etching allows the data line 6a to be patterned. In this case, since the step of the second interlayer insulating film 42 as a base is considerably planarized, etching residues are hardly generated and a surface state after patterning is enhanced.

Next, in a process of FIG. 6B, a third interlayer insulating film 43, a pixel electrode 9a, and an alignment film 16 are formed. The third interlayer insulating film 43 is formed as a silicate glass film made of PSG, BSG or BPSG, a silicon nitride film or a silicon oxide film by, for example, an atmospheric pressure or reduced-pressure CVD method. It is necessary to form the third interlayer insulating film 43 at a relatively low temperature of, for example, 400° C. or less, because the Al-containing data line 6a exists under the third interlayer insulating layer. In addition, the top face of the third interlayer insulating film 43 becomes a face that has little unevenness, though any treatment is not performed thereon, by the influence of the planarizing treatment that was performed on the interlayer insulating films 41 and 42.

Subsequently, a contact hole 85 that leads to the lower capacitor electrode 71 is formed by dry etching, such as reactive ion etching and reactive ion beam etching, on the third interlayer insulating film 43, an ITO film is formed by sputtering treatment, and a pixel electrode 9a is formed by performing photolithography and etching.

Thereafter, the pixel electrode is coated with polyimide-based coating liquid for an alignment film, and is subjected to alignment treatment, such as rubbing treatment, in a predetermined direction to have a predetermined pretilt angle, so that an alignment film 16 is formed. In this case, since the top face of the third interlayer insulating film 43 as a base of the alignment film 16 is almost flat, alignment treatment can be satisfactorily performed, so that an electro-optical device in which an aligned state of liquid crystal is better controlled can be manufactured. Further, the aligned state of liquid crystal corresponds to the distance between substrates. Therefore, the distance between substrates is made uniform to make the aligned state of liquid crystal uniform over the entire display surface, so that the display quality of an electro-optical device can be enhanced.

Further, the height of a step provided on the third interlayer insulating film 43 may be 600 to 1200 nm. The third interlayer insulating film 43 is reflowed so that the angle of inclination of the lateral face of the step is made gentle and the height of the step is kept substantially constant before and after reflow. When the step is angled, the number of times of rubbing is increased to raise the rubbing density, or the number of rotations at the time of rubbing is increased, so that display defects, such as strips and spots, can be decreased. However, when the rubbing is performed while the number of times of rubbing is increased or the number of rotations at the time of rubbing is increased, the alignment film may be peeled off. Such peeling-off of the alignment film hinders the rubbing density from being raised, and may become a striped display defect. The height of a step on the top face of the third interlayer insulating film 43 may be, for example, 600 to 1200 nm. Moreover, since such a step is subjected to planarizing treatment so that the inclination of the lateral face thereof is made gentle, the top face of the third interlayer insulating film 43 becomes a flat face to the degree that the alignment film is hardly peed off. Accordingly, the rubbing density of the alignment film formed above the third interlayer insulating film 43 can be raised, so that a striped display defect can be reduced. It is noted that the alignment film peeling is also prevented from being peeled off. Further, the height of 600 to 1200 nm of the step is enough to reduce a transverse electric field applied to liquid crystal of a liquid crystal display device and to reduce display defects caused by disorder of alignment of liquid crystal molecules.

In this way, the TFT array substrate 10 is efficiently manufactured with a high yield.

With regard to the counter substrate 20, a glass substrate or the like is first prepared as the counter substrate 20. An ITO film is deposited on the entire surface of the counter substrate to have a thickness of about 50 to 200 nm, using a sputtering treatment or the like. As a result, a counter electrode 21 is formed. Moreover, after the entire surface of the counter electrode 21 is coated with polyimide-based coating liquid for an alignment film, it is subjected to rubbing treatment or the like in a predetermined direction to have a predetermined pretilt angle, so that an alignment film 22 is formed.

Finally, the TFT array substrate 10 and the counter substrate 20 in which each layer is formed as described are adhered to each other with a sealing material such that alignment films 16 and 22 faces each other. As such, the liquid crystal in which, for example, plural kinds of nematic liquid crystal are mixed with each other, are injected into a space formed between both substrates, so that a predetermined film thickness of liquid crystal 50 is formed.

The manufacturing processes as described above enables the above electro-optical devices to be manufactured.

As described above, in the present exemplary embodiment, each of the first interlayer insulating film 41 and second interlayer insulating film 42 is formed as a BPSG film, and it is subjected to planarizing treatment by reflow, thereby reducing steps of the top face thereof. Thus, it is possible to reduce etching residues that may be generated when the storage capacitor 70, and the data line 6a formed on the first and second interlayer insulating films are patterned. In addition, since the interlayer insulating films are originally subjected to heat treatment, they are subjected to planarizing without increasing the number of processes. This simple and easy method enables the manufacturing yield of electro-optical devices to increase. Further, the planarizing treatment is performed using a single wafer processing method so that the manufacturing efficiency can be considerably enhanced. Moreover, the top face of the third interlayer insulating film 43 is decreased in unevenness by the influence of planarizing treatment performed on the interlayer insulating films 41 and 42 thereunder. Therefore, although CMP treatment is not performed, the alignment treatment of an alignment film can be sufficiently uniformly performed. Specifically, it is possible to provide an electro-optical device that has enhanced display quality as well as many advantages in that a CMP treatment process for planarizing the substrate surface is omitted, and bad effects, such as damage to the substrate caused by mechanical polishing is reduced or eliminated.

In the above exemplary embodiment, the planarizing treatment is not performed on the third interlayer insulating film 43 formed on the wiring layer containing Al. However, the top face of the third interlayer insulating film 43 may be planarized using any technique other than heating, such as the CMP treatment. As described above, since the unevenness on the top face of the third interlayer insulating film 43 is reduced by the influence of planarizing treatment of the interlayer insulating films 41 and 42, it is possible to perform uniform polishing treatment on the entire substrate surface in addition to reducing a possibility that the polishing strength is lowered or the substrate is damaged. Further, even if any one of the interlayer insulating films 41 and 42 are subjected to planarizing treatment by reflow, it contributes to planarizing.

### General Construction of Electro-optical Device

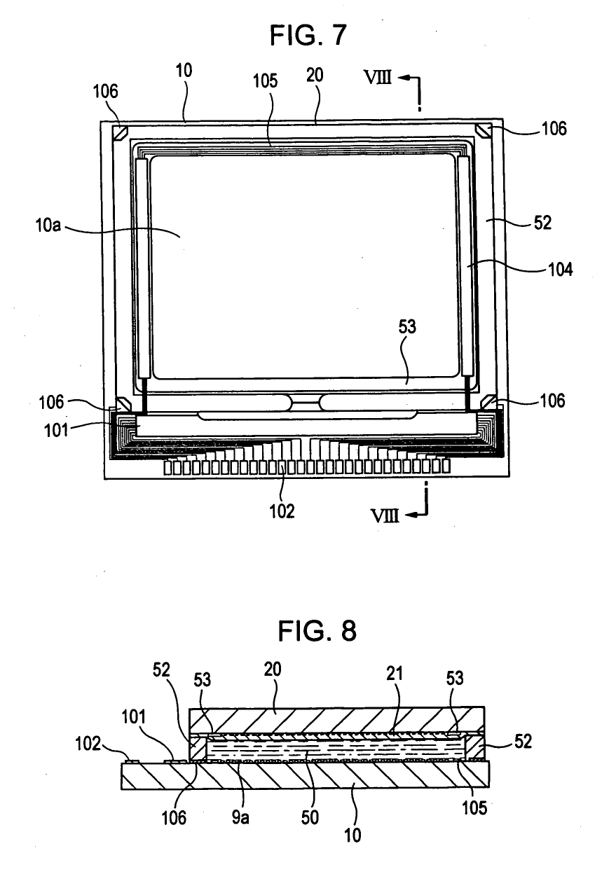

The general construction of the electro-optical device as described above will be described with reference to FIG. 7 and FIG. 8. FIG. 7 is a schematic of a TFT array substrate 10, together with various elements formed thereon, as seen from a counter substrate 20. FIG. 8 is a sectional view taken along the plane H-H′ in FIG. 12.

In FIG. 7, a sealing material 52 is provided on a TFT array substrate 10 along the periphery thereof. A frame-like light-shielding film 53 that defines the circumference of an image display region 10a is provided inside of the sealing material. Outside of the sealing material 52, a data line driving circuit 101 and an external circuit connection terminal 102 are provided along one side of the TFT array substrate 10. The data line driving circuit supplies image signals to data lines 6a at predetermined timing, thereby driving the data lines 6a. Further, a scanning line driving circuit 104 that supplies scanning signals to scanning lines 3a at predetermined timing to drive the scanning lines 3a is provided along two sides adjacent to the above side. If a problem does not occur that scanning signals to be supplied to the scanning lines 3a are delayed, the scanning line driving circuit 104 may be provided only on one side of the TFT array substrate. Two data line driving circuits 101 may be arranged on both sides of the image display region 10. Moreover, a plurality of wiring lines 105 are provided on the remaining one side of the TFT array substrate 10 to connect the scanning line driving circuits 104 to each other. Further, at least one of corners of the counter substrate 20 is provided with a conducting material 106 that make the TFT array substrate 10 and the counter substrate 20 electrically connected to each other. Also, the counter substrate 20 having substantially the same contour as the sealing material 52 is anchored to the TFT array substrate 10 with the sealing material 52 concerned.

On the TFT array substrate 10, a sampling circuit that applies image signals to a plurality of data lines 6a at predetermined timing, a precharge circuit that supplies a predetermined voltage level of precharge signals to the plurality of data lines 6a prior to the image signals, and a test circuit for testing the quality, defects or the like of the electro-optical device during manufacturing or on shipping may be formed in addition to the data line driving circuit 101, the scanning line driving circuit 104, or the like.

On the counter substrate 20 on which projection light is incident and the FTT array substrate 10 side from which emitting light emit, respectively, a polarizing film, a retardation film, or a polarizing plate, or the like is arranged in a predetermined direction according to an operation mode, such as a twisted nematic (TN) mode, a super twisted nematic (STN) mode, a vertically aligned (VA) mode, and a polymer dispersed liquid crystal (PDLC) mode, or a normally black/white mode.

The above-described electro-optical device is applied to, for example, a projector. In that case, three liquid crystal devices are respectively used as light valves for three primary colors of RGB. Colored light beams separated via dichroic mirrors for color separation of RGB are respectively projected onto the corresponding light valves. Further, the electro-optical device of the exemplary embodiment can be applied to a direct-viewing-type or reflective color display device other than the projector. In that case, color filters of RGB together with protective films thereof may be formed in regions on the counter substrate 20 that face the pixel electrodes 9a. Alternatively, a color resist layer may be formed of color resist or the like under the pixel electrodes 9a on the TFT array substrate 10 that face RGB colors. Moreover, in this aspect, if micro-lenses are formed on the counter substrate 20 so that one micro-lens corresponds to one pixel, the condensation efficiency of incident light is enhanced. Thus, the display brightness can be enhanced. Furthermore, several interference layers having different refractive indexes are deposited on the counter substrate 20, so that dichroic filters that make up RGB colors using interference of light may be formed. According to the counter substrate with the dichroic filters, brighter display can be made.

In the above description, the data line driving circuit 101 and the scanning line driving circuit 104 are provided on the TFT array substrate 10. However, they may be electrically and mechanically connected to a driving LSI mounted on, for example, a tape automated bonding (TAB) substrate, via an anisotropic conductive film provided at the periphery of the TFT array substrate 10, instead.

### Electronic Apparatus

Next, cases in which the electro-optical device as described above in detail is applied to various apparatuses will be described.

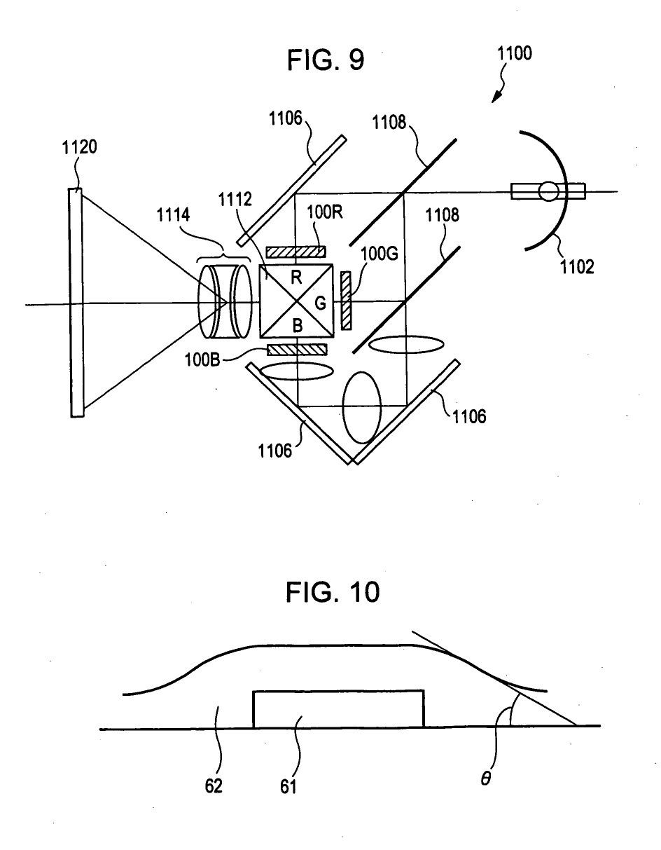

Here, a projector will be described in which a liquid crystal device that is the electro-optical device is used as a light valve. FIG. 9 is a schematic illustrating a constructional example of the projector. As shown in the drawing, a lamp unit 1102 including a white light source, such as a halogen lamp is provided in a projector 1100. Projection light emitted from the lamp unit 1102 is divided into light components of three primary colors of RGB by four mirrors 1106 and two dichroic mirrors 1108 arranged in a light guide. The divided light components enter liquid crystal devices 100R, 100B and 100G as light valves corresponding to the respective primary colors. The construction of the liquid crystal devices 100R, 100B and 100G is the same as that of the above-described liquid crystal device. Primary color signals of R, G and B supplied from an image signal processing circuit are modulated in the liquid crystal devices, respectively. The light components modulated by these liquid crystal devices enters a dichroic prism 1112 from three directions. In the dichroic prism 1112, the light components of R and B is refracted by 90 degrees, while the light component of G travels straight. As a result, an image including the respective colors is synthesized, and the synthesized color image is projected onto a screen 1120 via a projector lens 1114.

In the above description, the liquid crystal device is given as one specific example of the electro-optical device of an exemplary aspect of the present invention. However, in addition to the above, the electro-optical device of an exemplary aspect of the present invention can be realized as an electrophoresis device, such as an electronic paper, a display device (Field Emission Display and Surface-Conduction Electron-Emitter Display) that utilizes an electron emission element, or the like. Further, such an electro-optical device of an exemplary aspect of the present invention can be applied to various electronic apparatuses, such as a television receiver, a view finder type or monitor direct-viewing type video tape recorder, a car navigation apparatus, a pager, an electronic organizer, an electronic calculator, a word processor, a workstation, a television telephone, a POS terminal, an apparatus including a touch panel, other than the earlier described projector.

### EXAMPLES

Next, exemplary aspects of the present invention will be described with reference to FIGS. 10 to 12.

### Example 1

Similar to the above exemplary embodiment, an electro-optical device is manufactured. In that case, as shown in FIG. 10, a pattern 61 is formed on a quartz substrate, and a BPSG film 62 is formed over the entire surface of the quartz substrate to have a film thickness of 800 nm. The pattern 61 corresponds to the scanning line 3a in the exemplary embodiment, and the BPSG film 62 corresponds to the first interlayer insulating film 41 in the exemplary embodiment. Next, the substrate is heat-treated at 890° C., and the BPSG film 61 is subjected to planarizing treatment by reflow. After the planarizing treatment, the angle of inclination of a stepped portion of the BPSG film 62 caused by the pattern 61 is measured as a reflow angle θ.

The above processes are performed while the concentration of boron (B) of the BPSG film 62 is changed from 0.8 percent by weight to 5 percent by weight. In all the cases, the concentration of phosphorus (P) is 6 percent by weight.

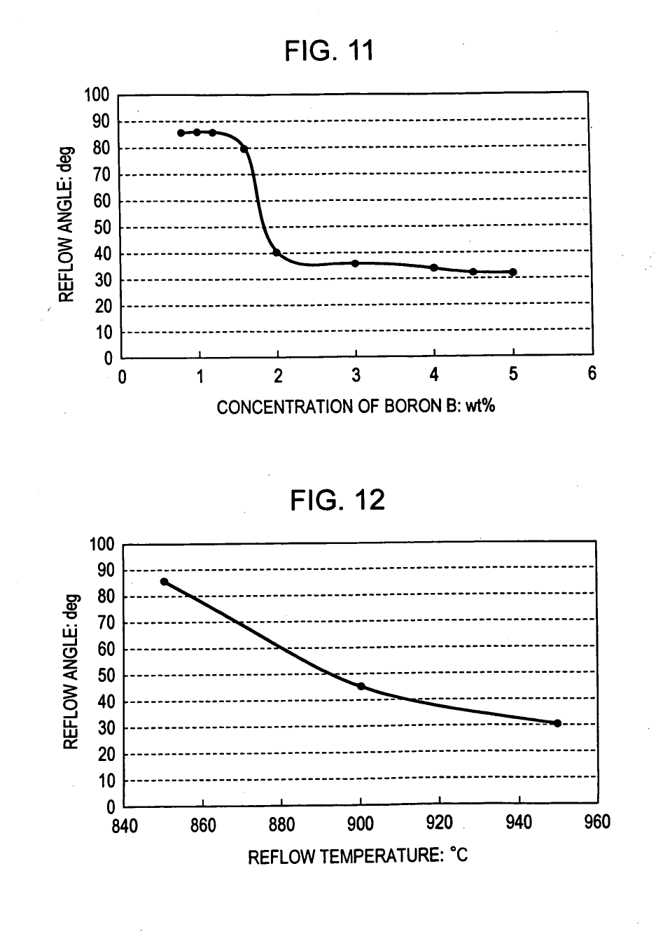

The measurement results obtained in these cases are shown in FIG. 11. FIG. 11 illustrates a change of the reflow angle θ with respect to the concentration of boron (B) doped to the BPSG film 62. In this case, when the concentration of boron is about 1.6 percent by weight or less, the flow angle θ changes in a range of 80° to 86°. However, when the concentration of boron is in a range of about 1.6 to 2 percent by weight, the reflow angle θ sharply decreases from 80° to 40°. Even if the concentration of boron increases above the range, the reflow angle θ changes between 40° and 30°.

It can be found from these results that, when the concentration of boron is 2 percent by weight or more, the BPSG film 61 is fluidized, and the top face thereof is planarized. Specifically, if the concentration of boron is low, a height difference caused in the BPSG film 62 by the pattern 61 has a steep angle of inclination of 80° to 90° close to perpendicularity. It is considered that this state is not greatly different from that before the planarizing treatment is performed. If a sufficient amount of boron is doped (2 percent by weight in this case), the angle of inclination is about 30° to 40°, and the height difference becomes gentle. As described above, the planarizing treatment according to an exemplary aspect of the present invention shows remarkable effects in planarizing the top face of an interlayer insulating film.

### Example 2

Similar to Example 1, an electro-optical device is manufactured. However, when a BPSG film 62 is formed on a quartz substrate in which a pattern 61 is formed, in this Example, the concentration of boron of the BPSG film 62 is fixed to 3 percent by weight and the concentration of phosphorus (P) is fixed to 6 percent by weight. In addition, planarizing treatment is performed while the heating temperature (reflow temperature) is changed to 850° C., 900° C., and 950° C., and the reflow angle θ is measured in the respective cases.

The measurement results obtained in these cases are shown in FIG. 12. FIG. 12 illustrates a change of the reflow angle θ with respect to the reflow temperature of the BPSG film 62. It can be understood that, at a reflow temperature of about 850° C., the reflow angle θ is about 86°, and the height difference is still steep. However, it can be understood that, at a reflow temperature of 900° C., the reflow angle θ is 45° C., and the height difference becomes quite gentle. Moreover, when the reflow temperature rises up to about 950° C., it can be understood that the reflow angle is 30°, and the height difference is further eliminated. As described above, as the reflow temperature gets higher, the fluidity of the BPSG film 62 gets higher, and the flatness on the top face of the BPSG film gets higher.

In Example 1, a case is exemplified in which the BPSG film 61 is fluidized in a concentration of boron of about 2 percent by weight or more. Generally, however, melting of the BPSG film 61 by heating is caused in a concentration of boron of 1 percent by weight or more in accordance with various conditions, such as the reflow temperature. Further, in Example 2, a case is exemplified in which the BPSG film 61 is fluidized at a reflow temperature of about 900° C. or more. Generally, however, melting of the BPSG film 61 by heating is caused at a reflow temperature of 600° C. or more in accordance with various condition, such as the concentration of boron.

### Example 3

Next, a situation in which phosphorus and boron precipitates is shown in Table 1. When a BPSG film in which the amount of phosphorus and boron change is formed, is a situation in which phosphorus and boron precipitates can be investigated by visual inspection. In addition, the flow rate of ozone in forming a BPSG film is kept constant (80 slm) in all samples.

TABLE 1

| P | B | P + B | Days of Pre- | |
|---|---|---|---|---|
| (Percent by | (Percent by | (Percent by | cipitation (any | Mass |
| weight) | weight) | weight) | of P and B) | Productivity |
| 5 | 4 | 9 | >7 days | ⊚ |
| 4 | 5 | 9 | 7 days | ◯ |
| 5 | 5 | 10 | 2 to 3 days | Δ |
| 5 | 6 | 11 | <1 day | × |
| 6 | 5 | 11 | <1 day | × |

As shown in Table 1, in a BPSG film whose total percent by weight of phosphorus and boron is 11 percent by weight, it is confirmed that phosphorus or boron precipitates in a day after the film is formed. Also, the present inventors have confirmed that, as the total percent by weight of phosphorus and boron decreases, the period until phosphorus or boron precipitates is prolonged. Further, in a condition that the total percent by weight of phosphorus and boron is 10 percent by weight or less, it takes two days or more until phosphorus and boron precipitates. Thus, it can be understood that it is preferable that a BPSG film whose total percent by weight of phosphorus and boron is 10 percent by weight or less is formed in a manufacturing process of mass production. Further, since phosphorus or boron does not precipitates for 7 days or more after film formation, the BPSG film whose total weight of phosphorus and boron is 9 percent by weight becomes an interlayer insulating layer more suitable for a process of mass production. Further, when the ratio of phosphorus is kept constant and the ratio of boron is changed from 6 percent by weight to 5 percent by weight, remarkable difference in days of precipitation can be observed. Thus, it is believed that the percent by weight of boron is, preferably, 5.5 percent by weight or less.

The present invention is not limited to the above-described exemplary embodiments. The present invention can be appropriately modified. A method of manufacturing an electro-optical device, the electro-optical device, and an electronic apparatus including the same, which are accompanied with such modifications, are included in the technical scope of exemplary aspects of the present invention.

1. A method of manufacturing an electro-optical device, comprising:
providing, above a substrate, display electrodes, at least one of wiring lines and electronic elements that drive the display electrodes, and an interlayer insulating film provided below the display electrodes to electrically insulate the display electrodes and at least one of the wiring lines and electronic elements from each other,
forming a boron phosphorus silicate glass film as the interlayer insulating film, and
subsequent to the film-forming, performing a first planarizing treatment on a top face of the boron phosphorus silicate glass film by heating the boron phosphorus silicate glass film to make it fluidized.

2. The method of manufacturing an electro-optical device according to claim 1, further including heating the boron phosphorus silicate glass film at a temperature of 600° C. or higher in the first planarizing.

3. The method of manufacturing an electro-optical device according to claim 2, further including heating the boron phosphorus silicate glass film at a temperature of 900° C. or lower in the first planarizing.

4. The method of manufacturing an electro-optical device according to claim 1, further including heating the boron phosphorus silicate glass film at a temperature of 600° C. to 850° C. for a reflow time of 15 to 30 minutes in the first planarizing.

5. The method of manufacturing an electro-optical device according to claim 1, further comprising:
forming at least parts of the wiring lines and/or electronic elements on the interlayer insulating film that has been subjected to the planarizing treatment,
forming an additional interlayer insulating film on the at least parts formed on the interlayer insulating film,
performing a second planarizing treatment carried out at a lower temperature than the first planarizing treatment on the formed additional interlayer insulating film, and
forming the display electrodes on the additional interlayer insulating film on which the second planarizing treatment has been performed.

6. The method of manufacturing an electro-optical device according to claim 1, further including carrying out the first planarizing by single wafer processing.

7. The method of manufacturing an electro-optical device according to claim 1, a groove being formed in the substrate, and, in the first planarizing, a recessed portion of the interlayer insulating film formed corresponding to the groove being chamfered by heating the interlayer insulating film.

8. A method of manufacturing an electro-optical device, comprising:
providing, above one of a pair of substrates, display electrodes, at least one of wiring lines and electronic elements that drive the display electrodes, and an interlayer insulating film provided below the display electrodes to electrically insulate the display electrodes and at least one of the wiring lines and electronic elements from each other;
providing a counter electrode to face the display electrodes on the other of the pair of substrates;
interposing an electro-optical material between the pair of substrates,
forming on the one substrate a boron phosphorus silicate glass film as the interlayer insulating film; and
subsequent to the film-forming, performing planarizing treatment on a top face of the boron phosphorus silicate glass film while a height of a convex portion formed on the top face of the boron phosphorus silicate glass film is maintained.

9. A method of manufacturing an electro-optical device, comprising:
forming thin film transistors above a substrate;
forming a boron phosphorus silicate glass film as an interlayer insulating film that covers the thin film transistors;
subsequent to the film-forming, performing a planarizing treatment on a top face of the boron phosphorus silicate glass film by heating the boron phosphorus silicate glass film to make it fluidized; and
forming data lines electrically connected to source regions of the thin film transistors, after the interlayer insulating film is formed.

10. A method of manufacturing an electro-optical device, comprising:
forming thin film transistors above a substrate;
forming a first interlayer insulating film that covers the thin film transistors;
forming storage capacitors on the first interlayer insulating film, each storage capacitor including a pixel-potential-side capacitor electrode that is electrically connected to a drain region of each of the thin film transistors and a fixed-potential-side capacitor electrode that is arranged to face the pixel-potential-side capacitor electrode, with a dielectric film therebetween;
forming a second interlayer insulating film that covers the storage capacitors;
forming on the second interlayer insulating film data lines electrically connected to source regions of the thin film transistors;
forming a third interlayer insulating film that covers the data lines; and
forming on the third interlayer insulating film pixel electrodes electrically connected to the pixel-potential-side capacitor electrodes,
forming at least one of the first interlayer insulating film and forming the second interlayer insulating film including:
forming boron phosphorus silicate glass films as the interlayer insulating films; and
subsequent to the film-forming, performing planarizing treatment on a top face of the boron phosphorus silicate glass film by heating the boron phosphorus silicate glass film to make it fluidized.

11. An electro-optical device, comprising:
a substrate;
display electrodes above the substrate;
at least one of wiring lines and electronic elements that drive the display electrodes; and
interlayer insulating films provided below the display electrodes to electrically insulate the display electrodes and at least one of the wiring lines and electronic elements from each other, at least one of the interlayer insulating films including a boron phosphorus silicate glass film and having its top face subjected to planarizing treatment by being put into a fluidized state.

12. The electro-optical device according to claim 11, the interlayer insulating film including the boron phosphorus silicate glass film containing boron (B) in a ratio of 1 percent by weight or more and phosphorus (P) in a ratio of 7 percent by weight or less.

13. The electro-optical device according to claim 12, the interlayer insulating film containing boron (B) in a ratio of 3 percent by weight or more and phosphorus (P) in a ratio of 5.5 percent by weight or less, and the total percent by weight of boron (B) and phosphorus (P) contained in the interlayer insulating film being 10 percent by weight or less.

14. The electro-optical device according to claim 11, at least one of the wiring lines and electronic elements containing aluminum (Al), and the interlayer insulating film including the boron phosphorus silicate glass film being provided below at least one of the wiring lines and electronic elements that contain the aluminum (Al).

15. An electro-optical device, comprising:
a substrate;
thin film transistors provided above the substrate;
an interlayer insulating film that covers the thin film transistors, the interlayer insulating film including a boron phosphorus silicate glass film and having its top face subjected to planarizing treatment by being put into a fluidized state; and
data lines on the interlayer insulating film electrically connected to source regions of the thin film transistors.

16. An electro-optical device, comprising:
a substrate;
thin film transistors provided above the substrate;
a first interlayer insulating film that covers the thin film transistors;
storage capacitors provided on the first interlayer insulating film, each storage capacitor including a pixel-potential-side capacitor electrode that is electrically connected to a drain region of each of the thin film transistors and a fixed-potential-side capacitor electrode that is arranged to face the pixel-potential-side capacitor electrode, with a dielectric film therebetween;
a second interlayer insulating film that covers the storage capacitors;
data lines arranged on the second interlayer insulating film which are electrically connected to source regions of the thin film transistors;
a third interlayer insulating film that covers the data lines; and
pixel electrodes arranged on the third interlayer insulating film which are electrically connected to the pixel-potential-side capacitor electrodes;
at least one of the first interlayer insulating film and the second interlayer insulating film being an interlayer insulating film that includes a boron phosphorus silicate glass film and whose top face has been subjected to planarizing treatment by being put into a fluidized state.

17. The electro-optical device according to claim 11, further comprising:
a counter substrate arranged to face the substrate; and
an electro-optical material interposed between the substrate and the counter substrate.

18. An electronic apparatus, comprising:
the electro-optical device according to claim 11.
